(19) United States
(12) Patent Application Publication
(10) Pub. No.: US 2007/0252292 A1
(43) Pub. Date: Nov. 1, 2007

(54) Mold unit for manufacturing plastic edged glass shelf, method for manufacturing plastic edged glass shelf using the same, and plastic edged glass shelf manufactured thereby

(75) Inventors: Sang Keun Choi, Gwangju-City (KR); Tae Ho Joo, Gwangju-City (KR); Jong Hoon Oh, Gwangju-City (KR); Eun Ha Lee, Gwangju-City (KR); Hyoung Min Go, Gwangju-City (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD, Suwon-si (KR)

(21) Appl. No.: 11/699,492

(22) Filed: Jan. 30, 2007

(30) Foreign Application Priority Data
Apr. 26, 2006 (KR) 10-2006-0037804

(51) Int. Cl. B29D 11/00; A23G 1/22; B29C 69/00

(52) U.S. Cl. 264/1.1; 264/241; 425/110

(57) ABSTRACT

A mold unit manufacturing a plastic edged glass shelf includes a first mold including a first support frame forming groove; a second mold including a second support frame forming groove; a support frame forming portion formed by the first and second support frame forming grooves; a seating portion receiving a glass sheet; and support pins formed in the support frame forming portion forming the edge of the glass sheet.

### CROSS-REFERENCE TO RELATED APPLICATIONS

This application claims the benefit of Korean Patent Application No. 10-2006-0037804, filed Apr. 26, 2006, in the Korean Intellectual Property Office, the disclosure of which is incorporated herein by reference.

### BACKGROUND OF THE INVENTION

1. Field of the Invention

The present invention relates to a mold unit manufacturing a plastic edged glass shelf, a method of manufacturing a plastic edged glass shelf using the same, and a plastic edged glass shelf manufactured thereby, and more particularly, to a mold unit manufacturing a plastic edged glass shelf, which prevents cracking or warping of a glass sheet when the shelf is manufactured, a method of manufacturing a plastic edged glass shelf using the same, and a plastic edged glass shelf manufactured thereby.

2. Description of the Related Art

Generally, glass shelves have good external appearances, and are not deformed even when the glass shelves are used for a long time with articles mounted thereon. Due to these qualities, glass is used in indoor cabinets and refrigerators.

Glass shelves use a glass sheet having designated dimensions and thickness according to an installation place and a purpose thereof. The glass sheet has a sharp edge and is easily damaged by external impact, thus requiring user's caution during use. For this reason, the edge of the glass sheet, if necessary, is surrounded with a member (made of synthetic resin) absorbing the external impact.

The installation of a support frame made of synthetic resin along the edge of the glass sheet is carried out by two methods. In the first method, a support frame, which is manufactured separately from a glass sheet, is connected to the glass sheet using connection members, such as screws. In the second method, a synthetic resin liquid is injected into a mold unit when a glass sheet is placed in the mold unit, to form a support frame along the edge of the glass sheet by injection molding.

In the first method, the support frame is manufactured by injection molding separately from the glass sheet, and is then connected to the glass sheet. Accordingly, if a manufacturing error is generated when the support frame is manufactured by injection molding, it is difficult to connect the support frame to the glass sheet and adhesive force between the support frame and the glass sheet is reduced.

An example of the method for manufacturing a glass shelf having a support frame by injection molding is Korean Utility Model Registration No. 20-299279 (filed Sep. 19, 2002). This reference discloses upper and lower molds, each having a flat surface for mounting a glass sheet thereon, and a method for manufacturing a glass shelf using the same.

In the method disclosed in this reference, the glass sheet is sucked through a suction port provided through the upper mold and contacts the flat surface of the mold, and an injection molding liquid is supplied to the glass sheet through holes formed through the circumference of the flat surface and forms a support frame along the edge of the glass sheet.

However, the glass sheet interposed between the upper and lower molds is not fixed to its correct position due to the pressure of the injection molding liquid when the injection molding liquid is injected into the molds, but is instead warped. Thus, the conventional molds and method have disadvantages in that the edge of the glass sheet is damaged by collision with the molds. Also, the glass shelf is manufactured by injection mold when the glass sheet is not located at the center of the support frame, thus lowering the quality of the glass shelf.

### SUMMARY OF THE INVENTION

Accordingly, it is an aspect of the present invention to provide a mold unit manufacturing a plastic edged glass shelf, which fixes a glass sheet interposed between a pair of molds to prevent the glass sheet from being deviated from a correct position and from being warped due to the pressure of an injection molding liquid injected into the mold unit, a method of manufacturing a plastic edged glass shelf using the same, and a plastic edged glass shelf manufactured thereby.

Additional aspects and/or advantages of the invention will be set forth in part in the description which follows and, in part, will be apparent from the description, or may be learned by practice of the invention.

The forgoing and/or other aspects are achieved by providing a mold unit manufacturing a plastic edged glass shelf, which comprises a glass sheet and a support frame surrounding an edge of the glass sheet, comprising a first mold including a first support frame forming groove; a second mold including a second support frame forming groove at a position corresponding to the first support frame forming groove; a support frame forming portion formed by the first support frame forming groove and the second support frame forming groove; a seating portion receiving the glass sheet so that the edge of the glass sheet is at the support frame forming portion; and support pins formed in the support frame forming portion supporting the edge of the glass sheet.

The support pins may support the edge of the glass sheet in a lengthwise direction of the glass sheet.

Further, the diameters of the support pins may be smaller than a thickness of the glass sheet.

The support pins may be tapered so that the diameters of the support pins are decreased from ends remote from the glass sheet to ends of the support pins close to the glass sheet.

The mold unit may further comprise actuators moving the support pins.

Pin support members supporting the support pins and horizontally moving together with the movement of the support pins toward the edge of the glass sheet by the actuators may be provided in the support frame forming portion.

The foregoing and/or other aspects are also achieved by providing a method of manufacturing a plastic edged glass shelf, which comprises a glass sheet and a support frame surrounding an edge of the glass sheet, comprising interposing the glass sheet between a first mold including a first support frame forming groove and a second mold including a second support frame forming groove in such a manner that the edge of the glass sheet is located at a support frame forming portion formed by the first mold and the second mold; supporting the edge of the glass sheet using support pins provided outside the edge of the glass sheet; forming a support frame at the edge of the glass sheet by injecting an injection molding liquid into the support frame forming portion; separating the support pins from the support frame; and separating the glass shelf from the first mold and the second mold.

The support pins may support two opposite surfaces of the edge of the glass sheet in a lengthwise direction of the glass sheet.

The supporting comprises supporting both side surfaces and a rear surface of the edge of the glass sheet, without supporting a front surface of the edge of the glass sheet.

The foregoing and/or other aspects may also be achieved by providing a plastic edged glass shelf comprising a glass sheet; and a support frame surrounding an edge of the glass sheet, the support frame defining connection holes connected to the edge of the glass sheet in a lengthwise direction of the glass sheet.

A plurality of the connection holes may be formed at opposite surfaces of the edge of the glass sheet so that the connection holes at the opposite surfaces face each other.

The connection holes may be formed through side surfaces and a rear surface of the edge of the glass sheet, without being formed through a front surface of the edge of the glass sheet.

The connection holes may be tapered so that the diameters of the connection holes decrease from ends of the connection holes remote from the glass sheet to ends of the connection holes close to the glass sheet.

### BRIEF DESCRIPTION OF THE DRAWINGS

These and/or other aspects and advantages of the invention will become apparent and more readily appreciated from the following description of the embodiments, taken in conjunction with the accompanying drawings in which:

FIG. 1 is a schematic exploded perspective view of a mold unit manufacturing a plastic edged glass shelf in accordance with an embodiment of the present invention;

FIGS. 2 to 6 are sectional and plan views illustrating a process of manufacturing a plastic edged glass shelf using the mold unit in accordance with the embodiment of the present invention of FIG. 1;

FIG. 7 is a schematic plan view of a plastic edged glass shelf in accordance with the embodiment of the present invention of FIG. 1;

FIG. 8 is a plan view of a mold unit manufacturing a plastic edged glass shelf in accordance with another embodiment of the present invention; and

FIG. 9 is a partial sectional view of a mold unit manufacturing a plastic edged glass shelf in accordance with yet another embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to like elements throughout. The embodiments are described below to explain the present invention by referring to the drawings.

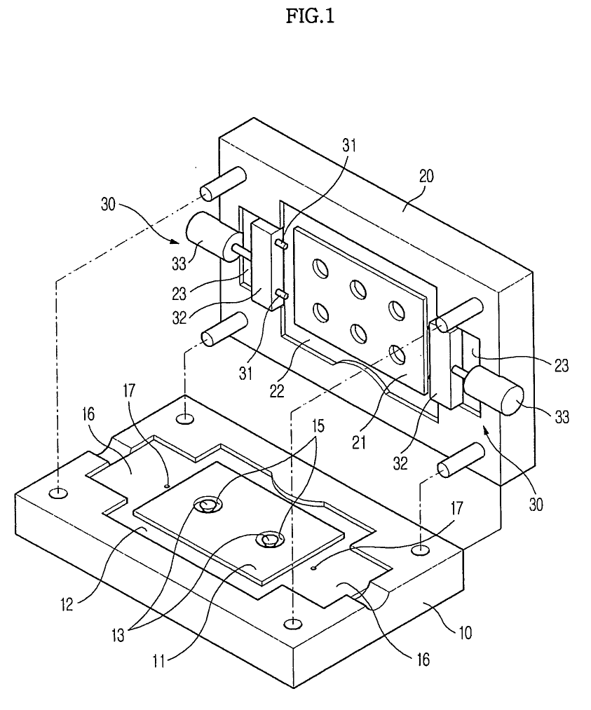

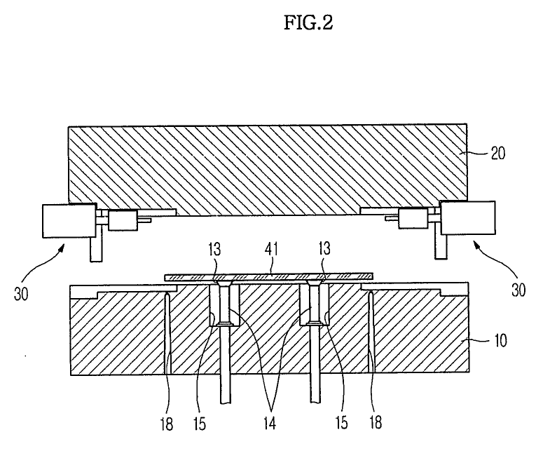

FIG. 1 is a schematic exploded perspective view of a mold unit manufacturing a plastic edged glass shelf in accordance with an embodiment of the present invention, and FIGS. 2 to 6 are sectional and plan views illustrating a process of manufacturing a plastic edged glass shelf using the mold unit in accordance with the embodiment of the present invention of FIG. 1.

As shown in FIG. 1, the mold unit in accordance with the embodiment of the present invention comprises a first mold 10 provided with a first support frame forming groove 12, a second mold 20 provided with a second support frame forming groove 22, and a pair of glass sheet supporters 30 supporting a glass sheet 41 (with reference to FIG. 2) interposed between the first mold 10 and the second mold 20.

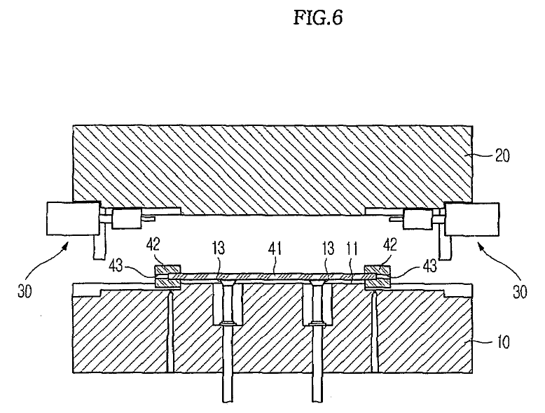

The first mold 10 includes a first central core 11, the first support frame forming groove 12, and a pair of suction pads 13. The first central core 11 is a flat portion, which is located at the center of the first mold 10 and contacts the lower surface of the glass sheet 41. The first support frame forming groove 12 is located around the first central core 11, and has a shape corresponding to the lower portion of a support frame 42 (with reference to FIG. 6) surrounding the edge of the glass sheet 41. A pair of first guide grooves 16 are provided at left and right side portions of the first support frame forming groove 12. The pair of first guide groves 16 serve to mount the glass sheet supporters 30 thereon.

The pair of suction pads 13 provide suction to the glass sheet 41 mounted on the first central core 11 so that the glass sheet 41 does not move. The suction pads 13 are installed in a pair of installation grooves 15, which are separated from each other, formed in the central core 11 in such a manner that the suction pads 13 can move vertically. As shown in FIG. 2, suction pipes 14 sucking air are respectively connected to the suction pads 13.

A pair of injection ports 17 are formed through the first support frame forming groove 12 of the first mold 10. An injection molding liquid made of synthetic resin forming the support frame 42 by injection molding is injected into the first support frame forming groove 12 through the pair of injection ports 17. As shown in FIG. 2, the injection ports 17 are respectively connected to injection channels extended to the outside of the first mold 10.

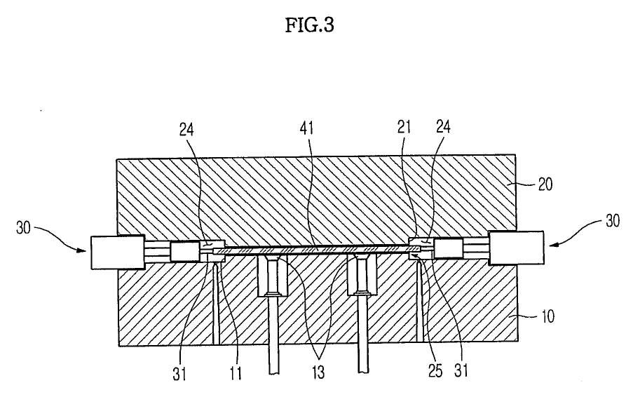

The second mold 20 is installed on the upper surface of the first mold 10 in such a manner that the second mold 20 can move vertically. The second mold 20 comprises a second central core 21, which, together with the first central core 11, forms a seating portion 25 (with reference to FIG. 3) receiving the glass sheet 41, and the second support frame forming groove 22 corresponding to the first support frame forming groove 12. The second central core 21 is a flat portion, which is located at the center of the second mold 20 and contacts the upper surface of the glass sheet 41. The second support frame forming groove 22 is located around the second central core 21, and has a shape corresponding to the upper portion of the support frame 42. The first support frame forming groove 12 and the second support frame forming groove 22 form a support frame forming portion 24 having the same shape as that of the support frame 42. A pair of second guide grooves 23 are provided at left and right side portions of the second support frame forming groove 12, and serve to mount the glass sheet supporters 30 thereon.

Each of the pair of glass sheet supporters 30 comprises a pair of support pins 31 for supporting the edge of the glass sheet 41 in the horizontal direction, a pin support member 32 supporting the support pins 31, and an actuator 33 moving the pin support member 32. Each of the support pins 31 has a rod shape having a circular cross section and a diameter smaller than the thickness of the glass sheet 41. The pin support member 32 is installed between the first and second guide grooves 16 and 23 in such a manner that the pin support member 32 can slidably move. The pin support member 32 moves close to and far away from the first and second support frame forming grooves 12 and 22 by the actuator 33, and causes the support pins 31 to contact the edge of the glass sheet 41 or to be separated from the edge of the glass sheet 41. Various devices, which move the pin support member 32, such as a pneumatic cylinder, a hydraulic cylinder, or a linkage, may be used as the actuator 33.

The pair of glass sheet supporters 30 face each other across the first and second central cores 11 and 21, and support both side surfaces of the glass sheet 41, thereby preventing the glass sheet 41 from inclining or warping to one side.

Hereinafter, with reference to FIGS. 2 to 6, a process of manufacturing a plastic edged glass shelf using the mold unit in accordance with the embodiment of the invention of FIG. 1 will be described.

First, as shown in FIG. 2, the glass sheet 41 is mounted on the suction pads 13 of the first mold 10 using a carrying device (not shown). Here, the suction pads 13 provide suction to the glass sheet 41 so that the glass sheet 41 cannot move.

After the glass sheet 41 is mounted on the suction pads 13, as shown in FIG. 3, the suction pads 13 descend so that the lower surface of the glass sheet 41 contacts the first central core 11, and the second mold 20 comes close to the first mold 10 so that the second core 21 contacts the upper surface of the glass sheet 41. Here, the supporting frame forming portion 24 having a designated space is formed around the glass sheet 41 between the first mold 10 and the second mold 20, and the glass sheet 41 is seated in the seating portion 25 in such a manner that the edge of the glass sheet 41 is located at the supporting frame forming portion 24. Thereafter, the pair of the glass sheet supporters 30 are simultaneously operated so that the support pins 31 of the glass sheet supporters 30 contact both side surfaces of the edge of the glass sheet 41, thereby firmly supporting the glass sheet 41.

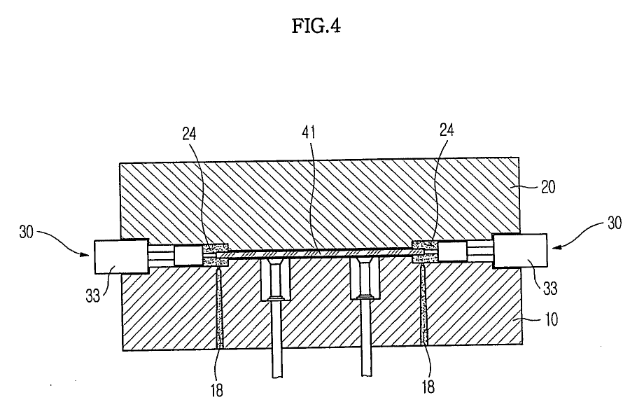

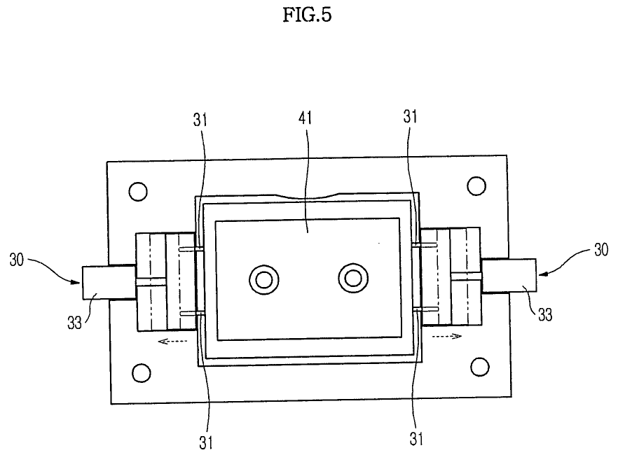

Then, as shown in FIG. 4, the injection molding liquid made of a synthetic resin is supplied through injection channels 18 of the first mold 10, thereby being injected into the support frame forming portion 24 between the first mold 10 and the second mold 20. When the injection molding liquid is injected into the support frame forming portion 24, as shown in FIG. 5, the edge of the glass sheet 41 is covered with the injection molding liquid.

The actuators 33 of the glass sheet supporters 30 are operated, and separate the support pins 31 from the edge of the glass sheet 41. It will be appreciated by those skilled in the art that a point of time when the support pins 31 are separated from the edge of the glass sheet 41 may be variously modified.

Thereafter, as shown in FIG. 6, the second mold 20 is separated from the first mold 10, and the suction pads 13 ascend to their original positions so that the lower surface of the glass sheet 41 is separated from the first central core 11. Then, the glass sheet 41 having the support frame 42 is separated from the first mold 10 using the carrying device.

A pair of the glass sheet supporters 30 firmly support the glass sheet 41 interposed between the first mold 10 and the second mold 20, thus the glass sheet 41 is not warped by the pressure of the injection molding liquid injected into the space between the first mold 10 and the second mold 20.

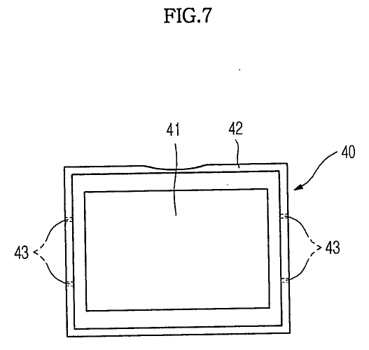

FIG. 7 is a schematic plan view of a plastic edged glass shelf 40 manufactured by the above-described process in accordance with the embodiment of the present invention.

As shown in FIG. 7, the plastic edged glass shelf comprises the glass sheet 41, and the support frame 42 surrounding the edge of the glass sheet 41. A plurality of connection holes 43 are formed through the support frame 42 by the support pins 31 of the glass sheet supporters 30. The connection holes 43 are formed in the horizontal direction through two opposite side surfaces of the support frame 42.

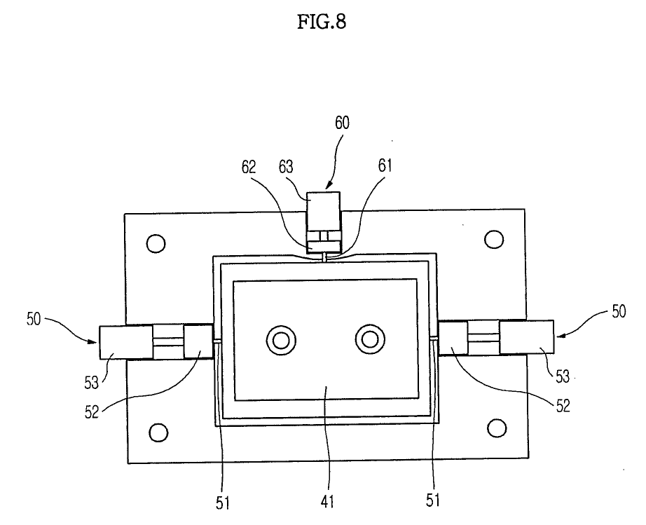

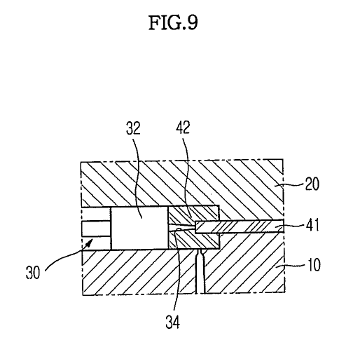

FIG. 8 is a plan view of a mold unit manufacturing a plastic edged glass shelf in accordance with another embodiment of the present invention, and FIG. 9 is a partial sectional view of a mold unit manufacturing a plastic edged glass shelf in accordance with yet another embodiment of the present invention.

Most parts of the mold unit shown in FIG. 8 are substantially the same as those in the embodiment of FIG. 1. The mold unit of FIG. 8 comprises three glass supporters 50 and 60, i.e., a pair of glass sheet supporters 50 supporting both side surfaces of the edge of the glass sheet 41 and another glass sheet supporter 60 supporting the rear surface of the edge of the glass sheet 41. Each of the glass sheet supporters 50 and 60 comprises a support pin 51 or 61 supporting the edge of the glass sheet 41, a pin support member 52 or 62 supporting the support pin 51 or 61, and an actuator 53 or 63 slidably moving the pin support member 52 or 62.

Other parts of the mold unit of the embodiment of FIG. 8 are substantially the same as those in the embodiment of FIG. 1, and a detailed description thereof will be thus omitted.

The plastic edged glass shelf 40 (with reference to FIG. 7) manufactured using the mold unit of the embodiment of FIG. 8 is provided through connection holes 43 corresponding to the support pins 51 and 61 formed through the both side surfaces and the rear surface of the support frame 42 (with reference to FIG. 7) except for the front surface of the support frame 42.

Most parts of the mold unit in the embodiment of FIG. 9 are substantially the same as those in the earlier embodiments except for the shape of support pins 34 of the glass sheet supporters 30. That is, in the mold unit of this embodiment, the support pins 34 of the glass sheet supporters 30 are tapered in such a manner that the diameters of the support pins 34 are decreased from ends thereof contacting the pin support members 32 to ends thereof close to the glass sheet 41. These tapered structures of the support pins 34 cause the connection holes 43, which are formed through the support frame 42 when the support frame 42 is formed by injection molding, to be tapered, thereby reducing the sizes of the connection holes 43.

As is apparent from the above description, the embodiments of the present invention provide a mold unit manufacturing a plastic edged glass shelf, in which the edge of a glass sheet interposed between first and second molds is supported by support pins, a method of manufacturing a plastic edged glass shelf using the same, and a plastic edged glass shelf manufactured thereby, thus preventing deviation of the glass sheet from its correct position, due to the pressure of an injection molding liquid injected into a space between the first and second molds, and damage to the edge of the glass sheet due to collision with the mold unit.

Thereby, it is possible to reduce the generation of defective glass shelves and to increase the reliability of the glass shelves.

Although a few embodiments of the invention have been shown and described, it would be appreciated by those skilled in the art that changes may be made in these embodiments without departing from the principles and spirit of the invention, the scope of which is defined in the claims and their equivalents.

What is claimed is:

1. A mold unit manufacturing a plastic edged glass shelf, which comprises a glass sheet and a support frame surrounding an edge of the glass sheet, comprising:
a first mold including a first support frame forming groove;
a second mold including a second support frame forming groove at a position corresponding to the first support frame forming groove;
a support frame forming portion formed by the first support frame forming groove and the second support frame forming groove;
a seating portion receiving the glass sheet so that the edge of the glass sheet is I at the support frame forming portion; and
support pins formed in the support frame forming portion supporting the edge of the glass sheet.

2. The mold unit according to claim 1, wherein the support pins support the edge of the glass sheet in a lengthwise direction of the glass sheet.

3. The mold unit according to claim 1, wherein diameters of the support pins are smaller than a thickness of the glass sheet.

4. The mold unit according to claim 3, wherein the support pins are tapered so that the diameters of the support pins decrease from ends of the support pins remote from the glass sheet to ends of the support pins close to the glass sheet.

5. The mold unit according to claim 1, further comprising actuators moving the support pins.

6. The mold unit according to claim 1,further comprising:
a plurality of actuators; and
pin support members supporting the support pins and moving in a lengthwise direction of the glass sheet together with movement of the support pins toward the edge of the glass sheet by the actuators.

7. A method of manufacturing a plastic edged glass shelf, which comprises a glass sheet and a support frame surrounding an edge of the glass sheet, comprising:
interposing the glass sheet between a first mold including a first support frame forming groove and a second mold including a second support frame forming groove in such a manner that the edge of the glass sheet is located at a support frame forming portion formed by the first mold and the second mold;
supporting the edge of the glass sheet using support pins provided outside the edge of the glass sheet;
forming a support frame at the edge of the glass sheet by injecting an injection molding liquid into the support frame forming portion;
separating the support pins from the support frame; and
separating the glass shelf from the first mold and the second mold.

8. The method according to claim 7, wherein the supporting comprises using the support pins to support two opposite surfaces of the edge of the glass sheet in a lengthwise direction of the glass sheet.

9. The method according to claim 7, wherein the supporting comprises supporting side surfaces and a rear surface of the edge of the glass sheet, without supporting a front surface of the edge of the glass sheet.

10. A plastic edged glass shelf comprising:
a glass sheet; and
a support frame surrounding an edge of the glass sheet, the support frame defining connection holes connected to the edge of the glass sheet in a lengthwise direction of the glass sheet.

11. The plastic edged glass shelf according to claim 10, wherein a plurality of the connection holes are formed at opposite surfaces of the edge of the glass sheet so that the connection holes at the opposite surfaces face each other.

12. The plastic edged glass shelf according to claim 10, wherein the connection holes are formed through side surfaces and a rear surface of the edge of the glass sheet, without being formed through a front surface of the edge of the glass sheet.

13. The plastic edged glass shelf according to claim 10, wherein the connection holes are tapered so that diameters of the connection holes decrease from ends of the connection holes remote from the glass sheet to ends of the connection holes close to the glass sheet.

14. A mold unit manufacturing a shelf comprising a glass sheet, comprising:
a mold defining a groove, a first edge of the sheet being received in the groove; and
a support pin supporting the first edge of the sheet.

15. The mold unit according to claim 14, wherein the pin has a diameter that decreases in a direction towards the sheet.

16. The mold unit according to claim 14, wherein the first edge is a first side edge, the sheet further comprising a second side edge and a rear edge, the second side edge and the rear edge being received in the groove, the mold unit further comprising a plurality of the pins to respectively support the second side edge and the rear edge.
